(19) United States
(12) Patent Application Publication
(10) Pub. No.: US 2005/0224475 A1
(43) Pub. Date: Oct. 13, 2005

(54) Laser beam processing machine

(75) Inventor: Keiji Nomaru, Tokyo (JP)

Correspondence Address: SMITH, GAMBRELL & RUSSELL, LLP, 1850 M STREET, N.W., SUITE 800, WASHINGTON, DC, 20036, US

(73) Assignee: Disco Corporation

(21) Appl. No.: 11/098,409

(22) Filed: Apr. 5, 2005

(30) Foreign Application Priority Data
Apr. 13, 2004 (JP) 2004-117496

(51) Int. Cl. B23K 26/08; B23K 26/03

(52) U.S. Cl. 219/121.82; 219/121.83

(57) ABSTRACT

A laser beam processing machine comprising a chuck table having a workpiece holding surface for holding a plate-like workpiece, a laser beam application means having a condenser for applying a laser beam from the top surface side of the workpiece held on the chuck table to form a focusing point, and a focusing point position adjusting means for moving the focusing point formed by the condenser in a direction perpendicular to the workpiece holding surface, wherein the machine further comprises a height position detection means for detecting the height position of an area to which a laser beam is applied from the condenser of the top surface of the workpiece held on the chuck table, and a control means for controlling the focusing point position adjusting means based on the height position detection signal of the height position detection means.

### FIELD OF THE INVENTION

The present invention relates to a laser beam processing machine for carrying out laser processing on a plate-like workpiece held on a chuck table along predetermined processing lines.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer, and a circuit such as IC, LSI or the like is formed in each of the sectioned areas. Individual semiconductor chips are manufactured by cutting this semiconductor wafer along the dividing lines to divide it into the areas having circuit formed thereon. An optical device wafer comprising gallium nitride-based compound semiconductors or the like laminated on the front surface of a sapphire substrate is also cut along dividing lines to be divided into individual optical devices such as light emitting diodes or laser diodes, which are widely used in electric equipment.

Cutting along the dividing lines of the above semiconductor wafer or optical device wafer is generally carried out by a cutting machine called “dicer”. This cutting machine comprises a chuck table for holding a workpiece such as a semiconductor wafer or optical device wafer, a cutting means for cutting the workpiece held on the chuck table, and a cutting-feed means for moving the chuck table and the cutting means relative to each other. The cutting means has a spindle unit, which comprises a rotary spindle, a cutting blade mounted onto the spindle and a drive mechanism for rotary-driving the rotary spindle. The cutting blade comprises a disk-like base and an annular cutting-edge which is mounted onto the side wall outer peripheral portion of the base, and is formed as thick as about 20 μm by fixing diamond abrasive grains having a diameter of about 3 μm to the base by electroforming.

Since a sapphire substrate, silicon carbide substrate, etc. have high Mohs hardness, cutting with the above cutting blade is not always easy. Further, since the cutting blade has a thickness of about 20 μm, the dividing lines for sectioning devices must have a width of about 50 μm. Therefore, in the case of a device measuring about 300 μm×300 μm, the area ratio of the streets to the wafer becomes 14%, thereby reducing productivity.

Meanwhile, as a means of dividing a plate-like workpiece such as a semiconductor wafer, a laser beam processing method for applying a pulse laser beam capable of passing through the workpiece with its focusing point set to the inside of the area to be divided is also attempted nowadays. In the dividing method making use of this laser beam processing technique, the workpiece is divided by applying a pulse laser beam of a wavelength of, for example, 1,064 nm, which is capable of passing through the workpiece, from one side of the workpiece with its focusing point set to the inside to continuously form a deteriorated layer along the dividing lines in the inside of the workpiece and exerting external force along the dividing lines whose strength has been reduced by the formation of the deteriorated layers. This method is disclosed by Japanese Patent No. 3408805.

When the plate-like workpiece such as a semiconductor wafer has an undulate surface and is not uniform in thickness, the deteriorated layers cannot be formed to a predetermined depth uniformly because of the refractive index at the time of application of a laser beam. Therefore, to form deteriorated layers to a predetermined depth uniformly in the inside of the semiconductor wafer, the unevenness of the area to which a laser beam is to be applied must be detected beforehand, and the laser beam application means must be adjusted to follow this unevenness.

Laser beam processing in which a laser beam is applied with its focusing point set to the inside of a plate-like workpiece to mark the inside of the workpiece is also implemented. However, to mark the inside of the workpiece to a predetermined depth, the laser beam application means must be adjusted to follow the unevenness of the surface of the workpiece.

To solve the above problem, JP-A 2003-168655 discloses a dicing machine which is provided with a height position detection means for detecting the height position of a workpiece placed on a work table to detect the height position of the cutting area of the workpiece through the height position detection means and make a cutting area height map, so that a cutting position of a cutting blade is controlled based on this map.

In the technology disclosed by the above publication, the cutting area height map is first prepared by detecting the height position of the cutting area of the workpiece by using the height position detection means and then, cutting processing is carried out while the cutting position of the cutting blade is controlled based on the map obtained. Since the height position detection step and the cutting step are separated from each other, this technology is not efficient in terms of productivity.

Under the circumstances, Japanese patent application No. 2003-388244 proposed by the applicant of the present application discloses a processing method capable of carrying out laser beam processing at a desired position of a plate-like workpiece efficiently even when it is not uniform in thickness. In this processing method, the height position of a surface on the surface side to be worked along a processing line right before a processing line along which laser beam processing is carried out, out of a plurality of processing lines formed on the workpiece held on the chuck table, is detected, and predetermined laser beam processing is carried out along the processing line while the laser beam processing means is controlled in a direction perpendicular to the to-be-worked face of the workpiece based on the detected height position.

However, since in the above-mentioned plate-like workpiece processing method, the height position of the to-be-worked surface is detected along a processing line right before the processing line along which laser beam processing is carried out, out of the plurality of processing lines formed on the plate-like workpiece and hence, the laser beam processing is not simultaneously carried out along the processing line whose height position has been first detected, the above method is not satisfactory in terms of productivity.

### SUMMARY OF THE INVENTION

It is an object of the present invention to provide a laser beam processing machine capable of carrying out processing at a desired position of a plate-like workpiece efficiently even when the workpiece is not uniform in thickness.

According to the present invention, the above object can be attained by a laser beam processing machine comprising a chuck table having a workpiece holding surface for holding a plate-like workpiece, a laser beam application means having a condenser for applying a laser beam from the top surface side of the workpiece held on the chuck table to form a focusing point, and a focusing point position adjusting means for moving the focusing point formed by the condenser in a direction perpendicular to the workpiece holding surface, wherein
the machine further comprises a height position detection means for detecting the height position of an area to which a laser beam is applied from the condenser of the top surface of the workpiece held on the chuck table, and a control means for controlling the focusing point position adjusting means based on the height position detection signal of the height position detection means.

The above height position detection means has a light-emitting means for applying a laser beam to the top surface of the workpiece held on the chuck table at a predetermined incident angle and a light-receiving means having a light position detector for receiving a laser beam that is applied from the light-emitting means and is reflected regularly from the surface, to which the laser beam is applied, of the workpiece. The light-emitting means and the light-receiving means of the height position detection means are arranged opposed to each other with the condenser therebetween. The application position of the laser beam applied from the light-emitting means of the height position detection means is so set to substantially correspond to the application position of a laser beam applied from the condenser.

In the laser beam processing machine of the present invention, since the height position of the application of a laser beam applied from the condenser of the workpiece held on the chuck table is detected by the height position detection means at all times and the control means controls the focusing point position adjusting means based on the detection signal, it makes possible to substantially eliminate a stroke for detecting the height position of the workpiece and to carry out laser beam processing at a desired position efficiently even when the workpiece is not uniform in thickness.

### BRIEF DESCRIPTION OF THE DRAWINGS

FIG. 1 is a perspective view of a laser beam processing machine constituted according to the present invention;

FIG. 2 is a block diagram showing the constitution of a laser beam processing means provided in the laser beam processing machine shown in FIG. 1;

FIG. 3 is a schematic diagram showing the focusing spot diameter of a laser beam applied from the laser beam processing means shown in FIG. 2;

FIG. 4 is a perspective view of a processing head and height position detection means provided in the laser beam processing machine shown in FIG. 1;

FIG. 5 is a diagram showing the positional relationship between the light-emitting means and light-receiving means of the height position detection means shown in FIG. 4 and the condenser of laser beam application means;

FIG. 6 is a diagram showing the detection state of the height position detection means shown in FIG. 4;

FIG. 7 is a perspective view of a semiconductor wafer as a plate-like workpiece;

FIGS. 8(a) and 8(b) are diagrams showing the step of processing the workpiece with the laser beam processing machine shown in FIG. 1; and

FIG. 9 is a diagram showing the processing step in a case where the workpiece is thick.

### DETAILED DESCRIPTION OF THE PREFERRED EMBODIMENT

A preferred embodiment of the present invention will be described in detail hereinunder with reference to the accompanying drawings.

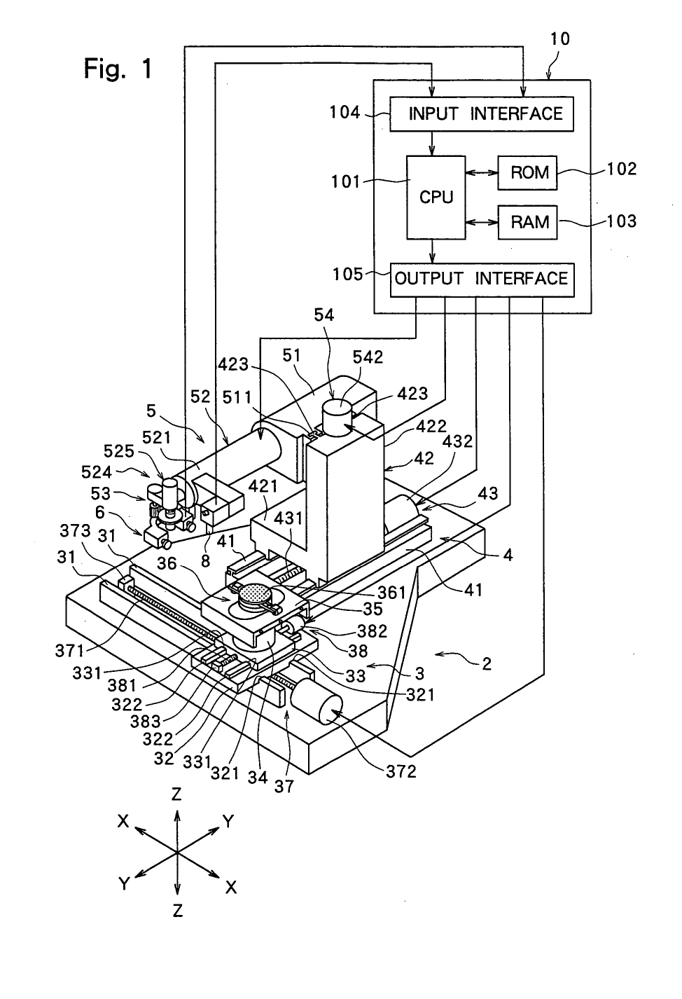

FIG. 1 is a perspective view of a laser beam processing machine constituted according to the present invention. The laser beam processing machine shown in FIG. 1 comprises a stationary base 2, a chuck table mechanism 3 for holding a plate-like workpiece, which is mounted on the stationary base 2 in such a manner that it can move in a processing-feed direction indicated by an arrow X, a laser beam application unit support mechanism 4 mounted on the stationary base 2 in such a manner that it can move in an indexing direction indicated by an arrow Y perpendicular to the direction indicated by the arrow X, and a laser beam application unit 5 mounted on the laser beam application unit support mechanism 4 in such a manner that it can move in a focusing point position adjusting direction indicated by an arrow Z.

The above chuck table mechanism 3 comprises a pair of guide rails 31 and 31 that are mounted on the stationary base 2 and arranged parallel to each other along the direction indicated by the arrow X, a first sliding block 32 mounted on the guide rails 31 and 31 in such a manner that it can move in the direction indicated by the arrow X, a second sliding block 33 mounted on the first sliding block 32 in such a manner that it can move in the direction indicated by the arrow Y, a support table 35 supported on the second sliding block 33 by a cylindrical member 34, and a chuck table 36 as workpiece holding means. This chuck table 36 has a workpiece holding surface 361 made of a porous material so that a disk-like semiconductor wafer as the plate-like workpiece is held on the workpiece holding surface 361 by a suction means that is not shown. The chuck table 36 is turned by a pulse motor (not shown) installed in the cylindrical member 34.

The above first sliding block 32 has, on its undersurface, a pair of to-be-guided grooves 321 and 321 to be fitted to the above pair of guide rails 31 and 31 and is, on its top surface, provided with a pair of guide rails 322 and 322 formed parallel to each other in the direction indicated by the arrow Y. The first sliding block 32 constituted as described above is so constituted as to be moved in the direction indicated by the arrow X along the pair of guide rails 31 and 31 by fitting the to-be-guided grooves 321 and 321 to the pair of guide rails 31 and 31, respectively. The chuck table mechanism 3 in the illustrated embodiment has a processing-feed means 37 for moving the first sliding block 32 along the pair of guide rails 31 and 31 in the direction indicated by the arrow X. The processing-feed means 37 comprises a male screw rod 371, which is arranged between the above pair of guide rails 31 and 31 in parallel to them, and a drive source such as a pulse motor 372 for rotary-driving the male screw rod 371. The male screw rod 371 is, at its one end, rotatably supported to a bearing block 373 fixed on the above stationary base 2 and is, at its other end, transmission-coupled to the output shaft of the above pulse motor 372 by a speed reducer that is not shown. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the processing-feed direction indicated by the arrow X.

The above second sliding block 33 has, on its undersurface, a pair of to-be-guided grooves 331 and 331 to be fitted to the pair of guide rails 322 and 322 provided on the top surface of the above first sliding block 32, and is so constituted as to be moved in the direction indicated by the arrow Y by fitting the to-be-guided grooves 331 and 331 to the pair of guide rails 322 and 322, respectively. The chuck table mechanism 3 in the illustrated embodiment has a first indexing-feed means 38 for moving the second sliding block 33 in the direction indicated by the arrow Y along the pair of guide rails 322 and 322 provided on the first sliding block 32. The first indexing-feed means 38 comprises a male screw rod 381, which is arranged between the above pair of guide rails 322 and 322 in parallel to them, and a drive source such as a pulse motor 382 for rotary-driving the male screw rod 381. The male screw rod 381 is, at its one end, rotatably supported to a bearing block 383 fixed on the top surface of the above first sliding block 32 and is, at its other end, transmission coupled to the output shaft of the above pulse motor 382 by a speed reducer that is not shown. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the indexing-feed direction indicated by the arrow Y.

The above laser beam application unit support mechanism 4 comprises a pair of guide rails 41 and 41 that are mounted on the stationary base 2 and are arranged parallel to each other in the direction indicated by the arrow Y and a movable support base 42 mounted on the guide rails 41 and 41 in such a manner that it can move in the direction indicated by the arrow Y. This movable support base 42 is composed of a movable support portion 421 movably mounted on the guide rails 41 and 41 and a mounting portion 422 mounted on the movable support portion 421. The mounting portion 422 is provided with a pair of guide rails 423 and 423 extending in the direction indicated by the arrow Z on one of its flanks. The laser beam application unit support mechanism 4 in the illustrated embodiment has a second indexing-feed means 43 for moving the movable support base 42 along the pair of guide rails 41 and 41 in the direction indicated by the arrow Y. This second indexing-feed means 43 comprises a male screw rod 431, which is arranged between the above pair of guide rails 41 and 41 in parallel to them and a drive source such as a pulse motor 432 for rotary-driving the male screw rod 431. The male screw rod 431 is, at its one end, rotatably supported to a bearing block (not shown) fixed on the above stationary base 2 and is, at its other end, transmission-coupled to the output shaft of the above pulse motor 432 by a speed reducer that is not shown. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction with the pulse motor 432, the movable support base 42 is moved along the guide rails 41 and 41 in the indexing-feed direction indicated by the arrow Y.

The laser beam application unit 5 in the illustrated embodiment comprises a unit holder 51 and a laser beam application means 52 as a processing means secured to the unit holder 51. The unit holder 51 has a pair of to-be-guides grooves 511 and 511 to be slidably fitted to the pair of guide rails 423 and 423 on the above mounting portion 422, and is supported in such a manner that it can move in the direction indicated by the arrow Z by fitting the to-be-guided grooves 511 and 511 to the above guide rails 423 and 423, respectively.

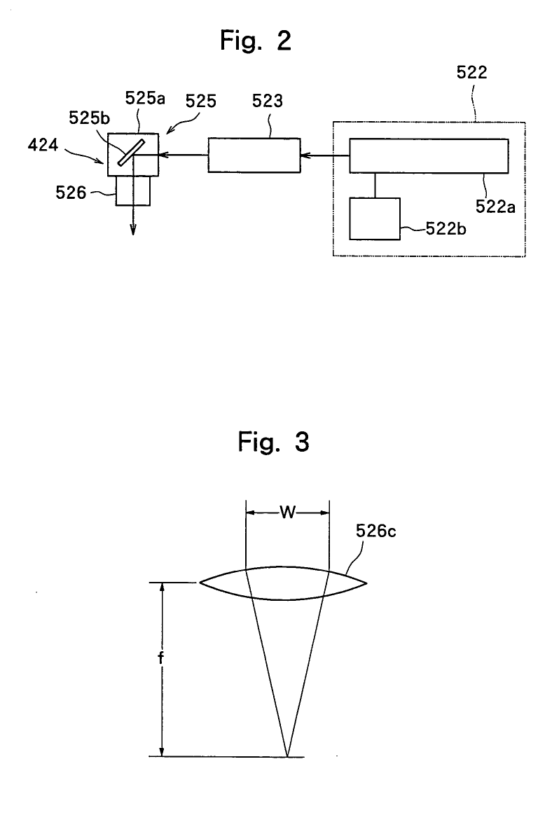

The illustrated laser beam application means 52 has a cylindrical casing 521 that is secured to the above unit holder 51 and extends substantially horizontally. In the casing 521, there are installed a pulse laser beam oscillation means 522 and a transmission optical system 523, as shown in FIG. 2. The pulse laser beam oscillation means 522 is constituted by a pulse laser beam oscillator 522a composed of a YAG laser oscillator or YVO4 laser oscillator and a repetition frequency setting means 522b connected to the pulse laser beam oscillator 522a. The transmission optical system 523 comprises suitable optical elements such as a beam splitter, etc.

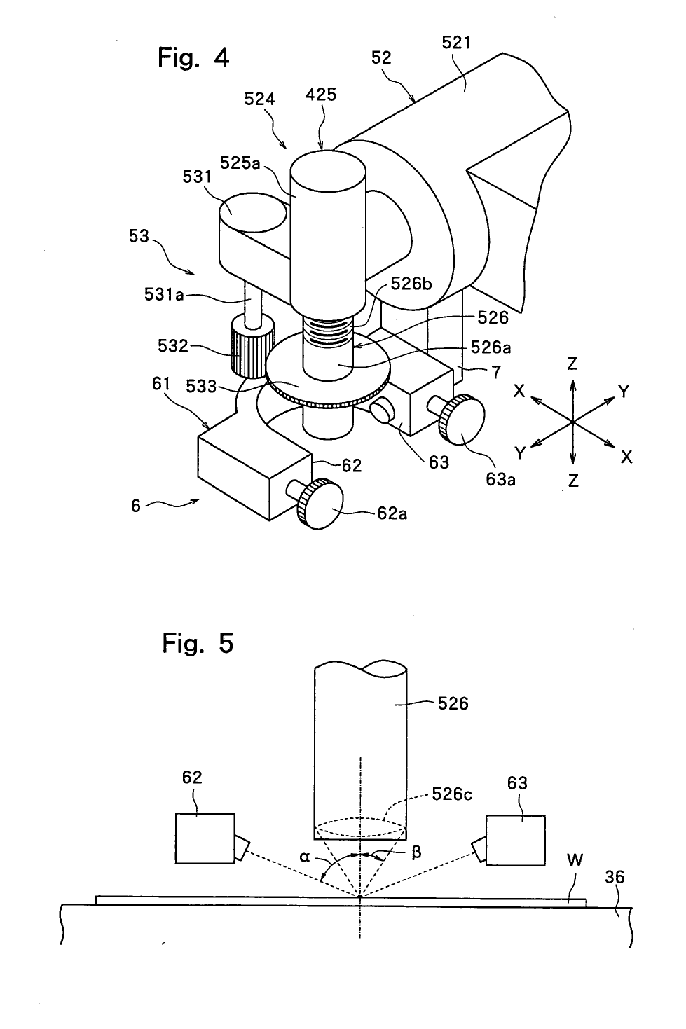

The laser beam application means 52 in the illustrated embodiment has a processing head 524 mounted onto the end of the above casing 521. This processing head 524 will be described with reference to FIG. 2 and FIG. 4.

The processing head 524 comprises a deflection mirror means 525 and a condenser 526 mounted onto the bottom of the deflection mirror means 525. The deflection mirror means 525 comprises a mirror case 525a and a deflection mirror 525b that is installed in the mirror case 525a (see FIG. 2). The deflection mirror 525b deflects a laser beam applied from the above pulse laser beam oscillation means 522 through the transmission optical system 523 in a downward direction, that is, toward the condenser 526 as shown in FIG. 2.

Returning to FIG. 4, the condenser 526 has a condenser case 526a and a condenser lens (not shown) constituted by a known combination of lenses, which is installed in the condenser case 526a. A male screw 526b is formed on the outer peripheral wall face of the upper portion of the condenser case 526a, and the condenser case 526a is mounted to the mirror case 525a by screwing the male screw 526b into a female screw (not shown) formed on the inner peripheral wall face of the lower portion of the above mirror case 525a in such a manner that it can move in the direction (Z direction) perpendicular to the workpiece holding surface 361 of the above chuck table 36. Therefore, by moving the condenser case 526a relative to the mirror case 525a, the focusing point formed by the condenser case 526a can be moved in the direction indicated by the arrow Z.

In the laser beam application means 52 constituted as described above, a laser beam oscillated from the above pulse laser beam oscillation means 522 is deflected at 90° by the deflection mirror 525b through the transmission optical system 523 and reaches the condenser 526 as shown in FIG. 2, and is applied from the condenser 526 to the workpiece held on the above chuck table 36 at a predetermined focusing spot diameter D (focusing point). This focusing spot diameter D is defined by the expression D (μm)=4×λ×f/(π×W) (wherein λ is the wavelength (μm) of the pulse laser beam, W is the diameter (mm) of the pulse laser beam applied to an objective converging lens 526c, and f is the focusing distance (mm) of the objective converging lens 526c) when the pulse laser beam having a Gaussian distribution is applied through the objective converging lens 526c of the condenser 526 as shown in FIG. 3.

The laser beam application unit 5 in the illustrated embodiment has a first focusing point position adjusting means 53 for moving the above condenser 526 in the direction indicated by the arrow Z, that is, in the direction perpendicular to the workpiece holding surface 361 of the above chuck table 36 as shown in FIG. 4. The first focusing point position adjusting means 53 comprises a pulse motor 531 attached to the above mirror case 525a, a drive gear 532 mounted on a rotary shaft 531a of the pulse motor 531, and a driven gear 533 that is mounted on the outer peripheral face of the above condenser case 526a and is engaged with the drive gear 532. The thus constituted first focusing point position adjusting means 53 moves the condenser 526 in the focusing point position adjusting direction indicated by the arrow Z along the mirror case 525a by driving the pulse motor 531 in a normal direction or reverse direction. Therefore, the first focusing point position adjusting means 53 has a function to adjust the position of the focusing point of the laser beam applied from the condenser 526.

As shown in FIG. 1, the laser beam application unit 5 in the illustrated embodiment comprises a second focusing point position adjusting means 54 for moving the above unit holder 51 along the pair of guide rails 423 and 423 in the direction indicated by the arrow Z, that is, in the direction perpendicular to the workpiece holding surface 361 of the above chuck table 36. The second focusing point position adjusting means 54 comprises a male screw rod (not shown) arranged between the pair of guide rails 423 and 423 and a drive source such as a pulse motor 542 for rotary-driving the male screw rod, like the above feed means. By driving the male screw rod (not shown) in a normal direction or reverse direction with the pulse motor 542, the unit holder 51 and the laser beam application means 52 are moved along the guide rails 423 and 423 in the focusing point position adjusting direction indicated by the arrow Z.

The laser beam processing machine in the illustrated embodiment has a height position detection means 6 for detecting the height position of the laser beam application area of the top surface, that is, the surface to which a laser beam is applied, of the plate-like workpiece held on the above chuck table 36. The height position detection means 6 will be described with reference to FIGS. 4 to 6.

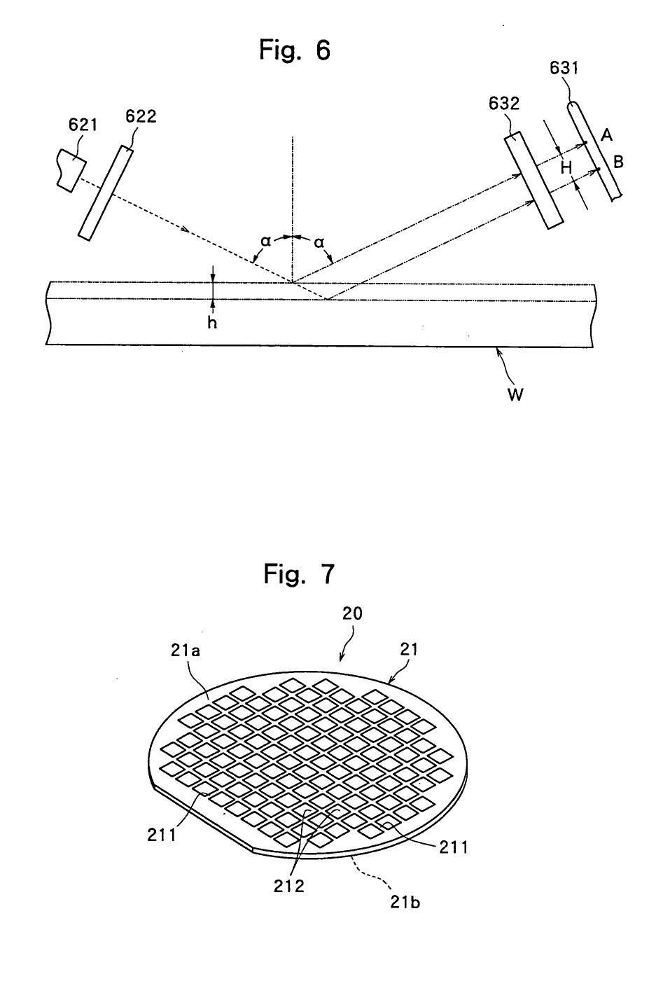

The height position detection means 6 in the illustrated embodiment comprises a U-shaped frame 61 as shown in FIG. 4, and this frame 61 is fixed to the casing 521 of the above laser beam application means 52 by a support bracket 7. A light-emitting means 62 and a light-receiving means 63 are installed in the frame 61 such that they are arranged opposed to each other in the direction indicated by the arrow Y with the above condenser 526 therebetween. The light-emitting means 62 has a light emitter 621 and a converging lens 622 as shown in FIG. 6. The light emitter 621 applies a pulse laser beam having a wavelength of, for example, 670 nm to the workpiece W held on the above chuck table 36 through the converging lens 622 at a predetermined incident angle α as shown in FIG. 5 and FIG. 6. The application position of the laser beam by the light-emitting means 62 is set to substantially correspond to the application position of a laser beam applied to the workpiece W from the condenser 526. The incident angle α is set to be larger than the converging angle β correspondent to the NA value of the objective converging lens 526c of the condenser 526 and smaller than 90°. The light-receiving means 63 comprises a light position detector 631 and a light receiving lens 632 and is located at a position where a laser beam applied from the above light-emitting means 62 is regularly reflected from the workpiece W. The height position detection means 6 in the illustrated embodiment has angle adjusting knobs 62a and 63a for adjusting the inclination angles of the above light-emitting means 62 and the light-receiving means 63, respectively. By turning the angle adjusting knobs 62a and 63a, the incident angle α of the laser beam applied from the light-emitting means 62 and the light receiving angle of the light-receiving means 63 can be adjusted, respectively.

A description will be subsequently given of the detection of the height position of the workpiece W by means of the height position detection means 6 constituted as described above, with reference to FIG. 6.

When the height position of the workpiece W is a position shown by a one-dot chain line in FIG. 6, a laser beam applied to the surface of the workpiece W from the light emitter 621 through the converging lens 622 is reflected as shown by the one-dot chain line and received at point A of the light position detector 631 through the light receiving lens 632. Meanwhile, when the height position of the workpiece W is a position shown by a two-dot chain line in FIG. 6, a laser beam applied to the surface of the workpiece W from the light emitter 621 though the converging lens 622 is reflected as shown by the two-dot chain line and received at point B of the light position detector 631 through the light receiving lens 632. Data thus received by the light position detector 631 is transmitted to a control means, which will be described later. The control means calculates the displacement “h” (h=H/sin α) of the height position of the workpiece W based on the interval “H” between the point A and the point B detected by the light position detector 631. Therefore, when the reference value of the height position of the workpiece W held on the above chuck table 36 is the position shown by the one-dot chain line in FIG. 6 and if the height position of the workpiece W shifts to the position shown by the two-dot chain line in FIG. 6, it is understood that the workpiece is displaced downward by the height “h”.

Returning to FIG. 1, an alignment means 8 for detecting the area to be processed by the above laser beam application means 52 is installed to the front end of the casing 521 constituting the above laser beam application means 52. This alignment means 8 in the illustrated embodiment comprises an infrared illuminating means for applying infrared radiation to the workpiece, an optical system for capturing infrared radiation applied by the infrared illuminating means, and an image pick-up device (infrared CCD) for outputting an electric signal corresponding to infrared radiation captured by the optical system, in addition to an ordinary image pick-up device (CCD) for picking up an image with visible radiation. An image signal is transmitted to the control means later described.

The laser beam processing machine in the illustrated embodiment has a control means 10. The control means 10 comprises a central processing unit (CPU) 101 for carrying out arithmetic processing based on a control program, a read-only memory (ROM) 102 for storing the control program, etc., a read/write random access memory (RAM) 103 for storing the results of operations, an input interface 104 and an output interface 105. Detection signals from the above height position detection means 6 and the alignment means 8 are input to the input interface 104 of the control means 10 constituted as described above. Control signals are output to the above pulse motor 372, pulse motor 382, pulse motor 432, pulse motor 531, pulse motor 542 and laser beam application means 52 from the output interface 105.

The laser beam processing machine in the illustrated embodiment is constituted as described above, and its operation will be described hereinbelow.

FIG. 7 is a perspective view of a semiconductor wafer as the plate-like workpiece. In the semiconductor wafer 20 shown in FIG. 7, a plurality of areas are sectioned by a plurality of dividing lines (processing lines) 211 (these dividing lines are parallel to one another) arranged in a lattice pattern on the front surface 21a of a semiconductor substrate 21 formed from a silicon wafer, and a circuit 212 such as IC, LSI or the like is formed in each of the sectioned areas.

The semiconductor wafer 20 constituted as described above is carried to the top of the workpiece holding surface 361 of the chuck table 36 of the laser beam processing machine shown in FIG. 1 and suction-held on the workpiece holding surface 361 in such a manner that the back surface 21b faces up. The chuck table 36 suction-holding the semiconductor wafer 20 is moved along the guide rails 31 and 31 by the operation of the processing-feed means 37 and is brought to a position right below the alignment means 8 mounted on the laser beam application unit 5.

After the chuck table 36 is positioned right below the alignment means 8, alignment work for detecting a processing area to be processed by a laser beam, of the semiconductor wafer 20 is carried out by the alignment means 8 and the control means 10. That is, the alignment means 8 and the control means 10 carry out image processing such as pattern matching, etc. to align a dividing line 211 formed in a predetermined direction of the semiconductor wafer 20 with the condenser 526 of the laser beam application unit 5 for applying a laser beam along the dividing line 211, thereby performing the alignment of a laser beam application position. Further, the alignment of the laser beam application position is also carried out similarly on dividing lines 211 formed on the semiconductor wafer 20 in a direction perpendicular to the above predetermined direction. At this moment, although the front surface 21a, on which the dividing line 211 is formed, of the semiconductor wafer 20 faces down, the dividing line 211 can be imaged from the back surface 21b as the alignment means 8 comprises an infrared illuminating means, an optical system for capturing infrared radiation and an image pick-up device (infrared CCD) for outputting an electric signal corresponding to the infrared radiation, etc., as described above.

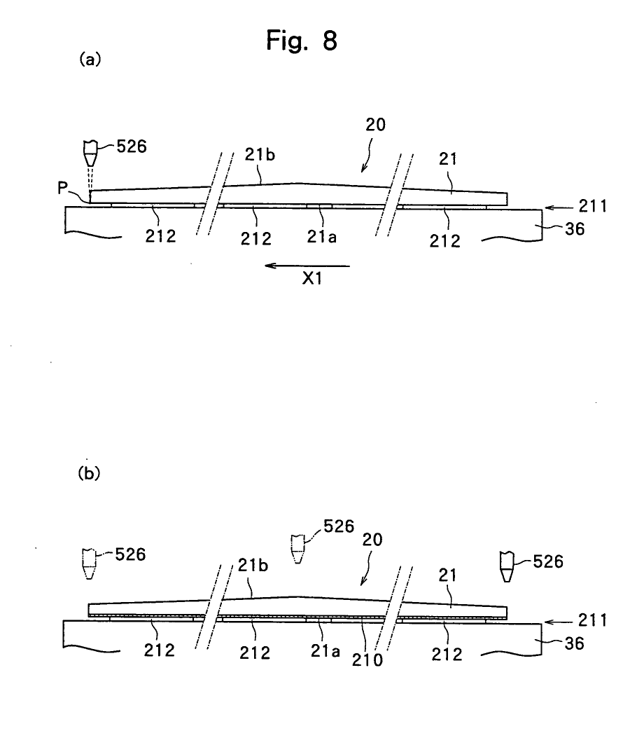

After the dividing line 211 formed on the semiconductor wafer 20 held on the chuck table 36 is detected and the alignment of the laser beam application position is carried out, the chuck table 36 is moved to bring one end (left end in FIG. 8(a)) of the predetermined dividing line 211 to a position right below the condenser 526 of the laser beam application means 52, as shown in FIG. 8(a). And, the focusing point P of a pulse laser beam applied from the condenser 526 is set near the front surface 21a (undersurface) of the semiconductor wafer 20. The chuck table 36 is then moved in the direction indicated by the arrow X1 at a predetermined processing-feed rate while the pulse laser beam is applied from the condenser 526 (processing step). When, as shown in FIG. 8(b), the application position of the condenser 526 reaches the other end (right end in FIG. 8(a)) of the dividing line 211, the application of the pulse laser beam is suspended, and the movement of the chuck table 36 is stopped. In this processing step, the height position of the application of the pulse laser beam applied from the condenser 526 is detected by the above height position detection means 6, and the detection signal of the height position detection means 6 is supplied to the control means 10 as occasion arises. The control means 10 calculates the displacement “h” of the height position (h=H/sin α) along the dividing line 211 of the semiconductor wafer 20 based on the detection signal of the height position detection means 6, and the control means 10 drives the pulse motor 531 of the focusing point position adjusting means 53 in a normal direction or reverse direction based on the calculated displacement “h” of the height position to move up or down the condenser 526. Therefore, in the above processing step, as shown in FIG. 8(b), the condenser 526 is moved up or down according to the height position along the dividing line 211. As a result, the deteriorated layer 210 formed in the inside of the semiconductor wafer 20 is uniformly exposed to the surface opposite to the surface to which the laser beam is applied (i.e., undersurface of the semiconductor wafer 20 held on the chuck table 36). In the laser beam processing machine in the illustrated embodiment, the height position of the application of the pulse laser beam applied from the condenser 526 of the semiconductor wafer 20 held on the chuck table 36 is detected by the height position detection means 6 at all times, and as the control means 10 controls the first focusing point position adjusting means 53 based on the detection signal, a stroke for detecting the height position of the semiconductor wafer 20 can be substantially eliminated, thereby making it possible to carry out laser beam processing at a desired position efficiently even when the semiconductor wafer 20 is not uniform in thickness.

The processing conditions in the above processing step are set as follows, for example.
Laser: YVO4 pulse laser
Wavelength: 1,064 nm
Repetition frequency: 100 kHz
Focusing spot diameter: 1 μm
Processing-feed rate: 100 mm/sec

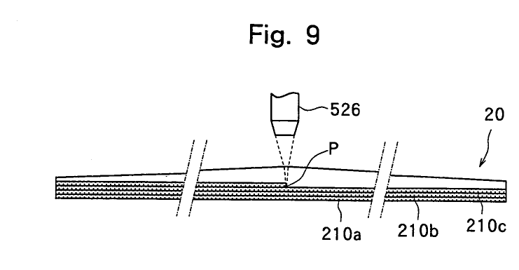

When the semiconductor wafer 20 is thick, the above laser beam application step is desirably carried out several times by changing the focusing point P stepwise to form a plurality of deteriorated layers 210a, 210b and 210c as shown in FIG. 9. As for the formation of the deteriorated layers 210a, 210b and 210c, the deteriorated layers 210a, 210b and 210c are preferably formed in this order by displacing the focusing point of the laser beam stepwise.

After the above processing step is carried out on all the dividing lines 211 extending in the predetermined direction of the semiconductor wafer 20 as described above, the chuck table 36 is turned at 900 to carry out the above processing step along dividing lines 211 extending in a direction perpendicular to the above predetermined direction. After the above processing step is carried out along all the dividing lines 211 formed on the semiconductor wafer 20, the chuck table 36 holding the semiconductor wafer 20 is returned to a position where it first suction-held the semiconductor wafer 20 to cancel the suction-holding of the semiconductor wafer 20. The semiconductor wafer 20 is carried to the dividing step by a conveying means that is not shown.

While a processing example in which the deteriorated layers 210 are formed in the inside of the semiconductor wafer 20 along the dividing lines 211 by using the laser beam processing machine constituted according to the present invention has been described above, a groove having a predetermined depth can be formed along the front surface of the workpiece by carrying out laser beam processing for forming a groove in the front surface of the workpiece by using the laser beam processing machine of the present invention. Since the surface condition of the workpiece is changed by the formation of the groove in this processing, the detection of the height position of the workpiece by the height position detection means 6 is carried out at a position 2 to 3 mm ahead of the processing point. The processing conditions for forming a groove are set as follows, for example.
Laser: YVO4 pulse laser
Wavelength: 355 nm
Repetition frequency: 100 kHz
Focusing spot diameter: 3 μm
Processing-feed rate: 60 mm/sec

1. A laser beam processing machine comprising a chuck table having a workpiece holding surface for holding a plate-like workpiece, a laser beam application means having a condenser for applying a laser beam from the top surface side of the workpiece held on the chuck table to form a focusing point, and a focusing point position adjusting means for moving the focusing point formed by the condenser in a direction perpendicular to the workpiece holding surface, wherein
the machine further comprises a height position detection means for detecting the height position of an area to which a laser beam is applied from the condenser of the top surface of the workpiece held on the chuck table, and a control means for controlling the focusing point position adjusting means based on the height position detection signal of the height position detection means.

2. The laser beam processing machine according to claim 1, wherein the height position detection means has a light-emitting means for applying a laser beam to the top surface of the workpiece held on the chuck table at a predetermined incident angle and a light-receiving means having a light position detector for receiving a laser beam that is applied from the light-emitting means and is reflected regularly from the surface, to which the laser beam is applied, of the workpiece.

3. The laser beam processing machine according to claim 2, wherein the light-emitting means and the light-receiving means of the height position detection means are arranged opposed to each other with the condenser therebetween.

4. The laser beam processing machine according to claim 2, wherein the application position of the laser beam applied from the light-emitting means of the height position detection means is so set to substantially correspond to the application position of a laser beam applied from the condenser.
